(19) United States
(12) Patent Application Publication
(10) Pub. No.: US 2002/0070481 A1
(43) Pub. Date: Jun. 13, 2002

(54) Automated molding and demolding system; mold; molding process employing pressurized demolding; and products made thereby

(76) Inventor: Luis Hernandez, Guatemala (GT)

Correspondence Address: Robert M. Schwartz, Esq., Ruden, McClosky, Smith Schuster & Russell, P.A., 200 East Broward Boulevard, Fort Lauderdale, FL, 33301, US

(21) Appl. No.: 10/013,296

(22) Filed: Dec. 10, 2001

Related U.S. Application Data
(60) Provisional application No. 60/254,629, filed on Dec. 11, 2000.

(51) Int. Cl. B29C 39/36

(52) U.S. Cl. 264/313; 425/261; 425/440; 425/DIG. 44; 264/334; 425/DIG. 58

(57) ABSTRACT

A one piece mold, having a cavity into which fluid material is fed through an input port, to result in a seamless, cast icon. At least the input port portion of the mold is sufficiently elastic so that it can be stretched open: (a) by the hardened icon, when positive pressure is applied into the cavity, remote from the input port; (b) by negative pressure applied around the mold, at least proximate to the input port; or (c) by a combination of such applied positive and negative pressures; to demold through the input port, the then hardened icon. An endless conveyor system carries the molds past several stations, including an icon demolding station, which applies the mold stretching pressure for the icon domolding. The applied pressure(s) does not exceed the elastic capability of the mold, so that it can be reused repeatedly, without deterioration as to form and shape of the icon.

### CROSS-REFERENCE TO RELATED APPLICATION

This application claims the benefit of U.S. Provisional Application Ser. No. 60/254,629, filed on Dec. 11, 2000, entitled MOLDING PROCESS EMPLOYING PRESSURIZED DEMOLDING; AND PRODUCTS MADE THEREBY.

### FIELD OF THE INVENTION

This invention concerns the manufacture of, cast molded objects, especially the mold, and the process of removing that object from the mold.

### BACKGROUND OF THE INVENTION

The manufacture of cast molded objects of different materials, sizes and uses is an ancient art, which has been improved upon in many ways, while retaining basic attributes of mold making, mold filling and mold emptying of the casting. The casting often is the finished product; or requires additional processing steps. The manufacture of cast or molded objects often is labor intensive and the initially demolded object often is of varying quality, as compared to the same object from the same mold, made recently prior to or soon after.

It would require volumes of information to discuss the history/background of molding process and apparatus, even if this background was limited to one-piece molds into the cavity of which fluid material is poured, the mold cavity being the negative of the resulting object. However, inasmuch as the present invention employs an elastic, one piece mold, it is appropriate to mention the prior art use of glove molds. Glove molds are very elastic and typically are of a thin material, having limited reusability. When the object in the glove mold has hardened, the thin mold manually is peeled back and off of the molded object. This type of demolding is labor intensive and slow; with the possibility of the molded object being broken during the peeling off of the mold, unless there is careful handling.

### SUMMARY OF THE INVENTION

As employed hereinafter, the cast molded, resulting object will be identified by the term “icon”, which is intended for any shape. The size, shape and volume of the icon can lie within a large range and primarily is limited by practical cooling/hardening time of the fluid material which is fed into the mold. The terms “elastic”, “flexible” and “resilient” are employed for the mold material in their normal technical meaning; however, the terms “expansion” and “stretching” of the mold material are to mean that, when the mold is reused, its cavity has returned to its original shape; whereby, numerous reuses of a cavity will result in nearly identical icons. The term “pressure” includes both, positive and negative (vacuum) pressure.

The present invention, its mold, molding and demolding system and process, produce a finished icon product more reliably, with less labor and cost. The mold is one piece, of elastic material, such as vulcanized rubber, having an internal cavity which is the negative of the object being molded. The mold has an input port for receiving the usually heated, liquid material, for filling the cavity. After the molded icon object has hardened sufficiently in the cavity, a source of air pressure is coupled to the mold and causes the icon object to be ejected or released out through the input port, which has been expanded sufficiently for the icon to leave the mold as a finished product. Ejection of the icon from the cavity of the mold can be by use of positive pressure into the cavity, via a second port, remote from the input port; whereby, the hardened icon is blown out the input port. Another manner of icon removal can be by use of vacuum, which is applied to exterior of the mold to thereby stretch it outwardly and enlargen the cavity, to free the icon.

### BRIEF DESCRIPTION OF THE FIGURES

FIG. 1 is a side elevation of the grommet-like mold;

FIG. 2 is a top view of the mold of FIG. 1;

FIG. 3 is a bottom view of the mold of FIG. 1;

FIG. 4 is a sectional view, taken along line 4-4 of FIG. 1;

FIG. 5 is a pictorial side view of a system, using the mold of FIG. 1, for manufacturing according to the invention;

FIG. 6 is a pictorial top view of the input portion of the system of FIG. 5; and

FIG. 7 is a pictorial side view of an alternate demolding station of the system of FIG. 5.

### DESCRIPTION OF PREFERRED EMBODIMENTS

As this description progresses, it will become evident that there can be employed numerous variables in: the design of the mold, the mounting of the mold into the conveyor portion of the system, and in fact almost all of the mechanics of the embodied system, without departing from the elastic capability of the mold during the pressurized demolding of the product. Icons well suited to be made according to this invention are decorative items, such as candles, parts of candles, soap, air fresheners, etc; however, larger and/or more complex icons can be the result of this invention.

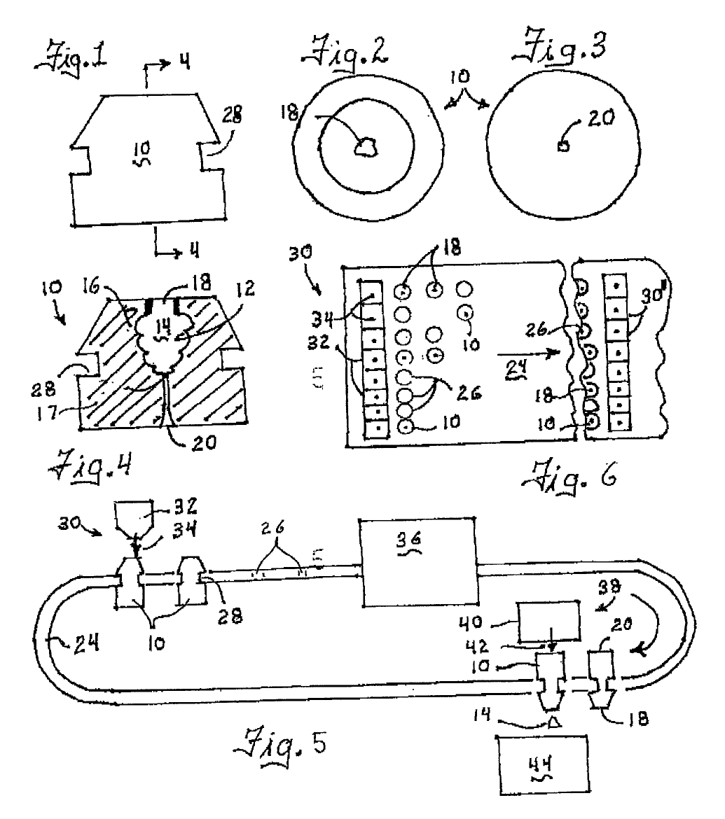

As shown in FIGS. 1 and 2, there is a mold 10 having sufficient interior shape and volume to contain a cavity 12, which is the negative of the icon 14, for example a strawberry shaped piece of candle or soap. The material of the mold 10 is to be elastic, such as vulcanized rubber, silicon and polyurethane resin, such that at least the portion 16 of the mold, between the input port 18 or sprue and the widest part of the icon 14, can be made to expand/stretch sufficiently for the icon to be forced/pushed/dropped out from the cavity 12, without structural damage to the mold or the icon.

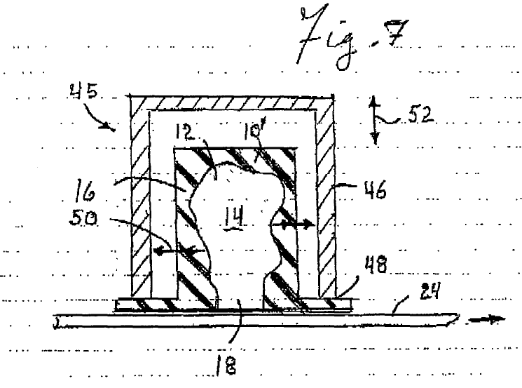

Although the mold 10 will be one piece or unitary, it can be a composite unit, of which the portion 16, proximate the port 18 and the cavity 12, is elastic; and a portion 17, remote from the cavity, is more rigid, for longer life of the mold. FIG. 4 does not show where the portions 16 and 17 meet, since that would be determined by the size, shape and position of the cavity 12.

The mold material, at least its cavity portion 16 and input port 18, usually needs to be able to receive heated liquids, which will be cast in the cavity 12 to form the icon 14. Temperatures of 50° C. to 150° C. are typical in the use of “waxes”, such as paraffin, polymide candle mixtures, vegetable fats, etc., having relatively low viscosity when heated to liquid or pourable consistency and then harden to yield the resulting icon. Mold material having high heat transfer is believed desirable, so that the icon material can cool and harden more quickly. It is envisioned that the liquid temperature could be as high as 400° C., without damaging the mold. The material for the icon can be self-hardening, of the well known types which are flowable, even when not heated, but harden by inclusion of a curing substance. Cooling/hardening time in the mold can be as short as ten minutes, but could be as long as eight hours, depending upon the “wax” or other flowable substance and the volume and shape of the cavity. As will be discussed subsequently with reference to FIG. 5, the mold could be put into a cooling or hardening chamber, to decrease the time needed for the icon to harden sufficiently to be ejected from the mold.

With reference to FIGS. 3 and 4, the mold 10 can be provided with a second port 20, a fluid pressure input port. The pressure input port 20 conveniently is locatable at the bottom of the mold, but could be located elsewhere, as long as its interior end 22 opens into the cavity 12 at a location appropriate for applying fluid pressure upon the hardened icon 14, to push or eject it out of the cavity 12, through the expansion portion 16 and out from material input port or sprue 18, which thereby become deformed. Air pressure in the range of 20 to 120 p.s.i. has been found effective, depending on the material of the mold, the material of the icon and its mass, shape, and volume. Gases and liquid other than air can be employed for ejecting the icon. Vacuum also can be the demolding force, without need for the port 20, as will be disclosed subsequently.

Looking next at FIGS. 5 and 6, which are pictorial side and top views one embodiment of a molding system, for using the mold 10, there is shown a conveyor belt 24, of the endless type. Positioned into the belt 24 are a few of the molds 10. For this embodiment, the belt 24 has numerous round holes 26, into each of which can be seated a mold. Each mold is provided with a groove 28, like a grommet, as shown in FIGS. 1, 4 and 5, with the belt 24 lying around the groove 28, as shown in FIG. 5. The holes 26 can be other than round or circular to accommodate and mate with the periphery of the groove 28, if that periphery is other than circular. The belt is shown driven clockwise, causing the molds on the top of the system to move from the left to right. Above the top left end of the belt is a mold filling station 30, having one or more hoppers 32 and associated infeed nozzles 34. One hopper can feed into several nozzles, as shown in FIG. 5, or there can be several hoppers 32, each dedicated to a single nozzle, as shown in FIG. 6. The hopper 32 can be filled with flowable/liquid substance and possibly have a warming coil or other warming and stirring means (not shown) for the icon material; or the hopper can be equipped to receive solid, waxy material for melting it into condition for delivery through a nozzle 34 into the input port 18 of a mold 10. The feed through the nozzle can be by gravity alone or by use of a small amount of pressure.

After leaving the filling station 30, the molds 10 advance along (to the right in FIGS. 5 and 6) while the icons 14 cool and/or begin to solidify. The speed of the conveyor can be about 50 centimeters a minute until the icons harden. If required, a cooling station 36 can be provided to reduce the cooling time. If the material used to make the icon contains hardening agents, the station 36 can be equipped with known means to reduce the hardening time. Further along the path of the conveyor belt 24, for example where the belt becomes inverted on its return path, there is an ejection station 38, having a manifold or plenum 40 and one or more pressure nozzles 42. When a mold 10, with its hardened icon 14, reaches the ejection station 38, one embodiment of that station forces enough fluid/air pressure into the pressure port 20 of the mold to blow the icon out through the infeed port 18 and into a receiving basket 44, which itself can be a conveyor leading to a sorting and packing station, not shown.

FIG. 7 shows another embodiment 45 of a demolding station, which operates on negative pressure/vacuum to separate the hardened icon from the mold and enable the icon to pass out from the input port 18 and place the icon into the receiving basket 44. The use of this demolding station 45 eliminates the need for the fluid pressure port 20 in the mold 10. As shown in FIG. 7, the conveyor belt 24 brings the mold 10 with its hardened icon 14 into the negative pressure station 45. Thereupon, negative pressure is applied around least the elastic portion 16 of the mold 10, to thereby expand, stretch or open the input port 18 and if necessary enlargen the cavity 12 sufficiently for the icon 14 to be released from the mold 10, for receipt by the basket 44.

For ease of understanding the operation of the demolding station 45, FIG. 7 is shown greatly enlarged over FIG. 5. The station 45 defines a vacuum chamber 46, which surrounds the mold 10′ and forms an air tight seal at a surface area of contact 48. The chamber 46 is sufficiently larger than the exterior of the mold 10′, so that when a vacuum is drawn, by means not shown, the elastic wall portion 16 of the mold, including input port 18, will be expanded outward toward the adjacent walls of the vacuum chamber, in the direction of the arrow heads 50. Such expansion also increases the volume of the mold cavity 12 and frees/releases/demolds the icon, so that its only support is the conveyor belt 24. If, as shown in FIG. 7, the conveyor belt 24 lies below the vacuum chamber 46, the chamber can be reciprocated vertically, as shown by the two-headed arrow 52, from the position shown in FIG. 7 to an elevated position, not shown, above the mold 10′; both prior to and subsequent to the demolding position shown in FIG. 7. Thus, the mold 10′ would be advanced on the belt 24 until the mold is below the vacuum chamber 45; then the chamber would be lowered to encompass the mold and demold the icon 14; after which the chamber 46 would be re-elevated, to permit the demolded icon to advance toward the basket 44. In such an orientation of the demolding station 45, the basket would be positioned near the beginning of the return path of the conveyor.

The cross-sectional surface area of the sprue or input port 18 can be larger than shown in FIGS. 4 and 7; and the cavity 12 can be as simple as cylindric; with relatively straight walls lying generally parallel to the exterior of the mold. Most important is that the size, shape and position of the cavity 12, in combination with the elasticity of the elastic portion 16, defines a mold 10, 10′ having sufficient body material, strength and elasticity such that the filling of the mold and/or the pressurized demolding do not cause deformation of the cavity 12, as occurs with a glove mold. Also, as described hereinabove, the mold of this invention is not designed to be peeled off from the icon, manually or otherwise, as is a glove mold.

Although the demolding station 45 should not require that the mold have the pressure port 20 and be assisted by some positive pressure ejection, as provided by the ejection station 38, certain icon designs and/or materials might benefit from ejection and mold expansion pressure provided by a combination of positive and negative pressure forces as provided by the demolding stations 42 and 45.

In the same way that the filling station 30 can be arranged to fill several molds at one time, as shown in FIG. 6, the vacuum station 45 can encompass several molds.

Thereupon, the empty molds advance back toward the filling station 30 for further use. Before reaching the filling station, a specific mold or molds can be replaced with other icon producing molds.

There can be more than one filling station, such as 30′ in FIG. 6, along the path of the conveyor belt 24. Thus, if the cavity 12 is less than filled at the first filling station 30, the cavity can be provided with a different layer of color and/or of substance at a second station 30′, to partially blend with or lie over the first filled substance. If needed, an additional cooling/hardening station can be positioned along the path of the belt 24, subsequent to the second filling station 30′.

Although FIGS. 5-7 describe a substantially fully automated system, the mold filling and/or demolding stations 30, 38 and 45 can be semi-manual, in that: the nozzle 34 can be hand held, with the hopper 32 being a source of pumpable icon material; the demolding pressure nozzle 42 be hand held directly against the pressure input port 20; and the demolding station 45, with its vacuum chamber 46, also can be hand held.

It is believed that those skilled in the art will appreciate the scope of the invention from this Specification with its figures, and will be able to design variations, without departing from the scope of the invention, as defined by the appended claims.

What I claimed is:

1. A mold having a cavity in which an icon is cast, said mold comprising:
an input port coupled to said cavity;
said input port dimensioned and positioned for receiving fluid material into which said icon is cast and for conducting said material into said cavity;
said input port lying within a first portion of said mold;
said first portion, proximate to said input port, being elastic;
said cavity and input port being constructed and arranged within said mold such that at least one of them can be stretched open sufficiently for the icon to be demolded from said cavity through said inlet port, without exceeding the elastic capability of said mold, or damaging the cast icon or said cavity.

2. A mold according to claim 1 in which:
said cavity also lies within said first portion of said mold.

3. A mold according to claim 1 in which:
said cavity is seamless; and
a second input port is provided into said cavity at position remote from said input port.

4. A mold according to claim 3 in which:
said second input port is constructed and arranged to couple to means for providing positive pressure into said cavity and upon the cast icon, to eject the icon from said cavity out through said input port, while stretching at least one of said input port and said cavity.

5. A mold according to claim 1 in which:
said mold has an exterior periphery configured to seat into transport means.

6. A mold according to claim 5 and in combination therewith:
transport means in the form of an endless conveyor belt, into which said mold is seated for transport within an icon molding and demolding system.

7. A system for casting an icon in a cavity of a mold and for demolding the icon, said system comprising:
means for moveably supporting at least one of said molds along a path;
a filling station adjacent said path, said filling station capable of holding fluid material and feeding said material into said cavity via an input port of said mold;
an icon demolding station positioned at such a distance along said path from said filling station that, when said moveable means places a mold adjacent said demolding station, the icon has hardened sufficiently to be demolded; and
said demolding station includes pressure means for applying fluid pressure to said mold to enlarge at least a portion of said cavity and said input port to free the icon from said cavity and enable it to exit out through said input port.

8. A system according to claim 7 in which:
said pressure means provides positive pressure into a second input port of said mold; and
said second input port is coupled into said cavity at a position remote from said input port.

9. A system according to claim 7 in which:
said mold around said input port is elastic, such that said input port is stretched open when the icon is being demolded.

10. A system according to claim 7 in which:
said pressure means provides negative pressure to the exterior of said mold to enlarge said cavity relative to the icon.

11. A system according to claim 10 in which:
said mold around said input port is elastic and said input port is stretched open when the icon is being demolded.

12. A system according to claim 11 in which the amount that said cavity and input port are stretched does not exceed the elastic capability of the mold.

13. A system according to claim 7 in which:
an icon cooling station is positioned along said path, between said filing and demolding stations.

14. A system according to claim 7 in which:
a second filling station is positioned along said path, for feeding fluid material into said cavity, via said input port.

15. A system according to claim 7 in which:
said mold is a one piece mold.

16. A system according to claim 15 in which:
said mold around said input port is elastic and stretches under the influence of said pressure means to facilitate the demolding of the icon; and
said pressure means provides at least one of positive and negative pressure.

17. A system according to claim 16 in which:
said pressure means applies said negative pressure to the exterior of said mold.

18. A method for casting an icon in the cavity of a one piece mold and then demolding the icon, said method comprising the steps of:
feeding a first fluid material for the casting into a first port of said one piece mold, said first port being in fluid communication with said cavity;
waiting for the fluid material to harden in said cavity; and
applying pressure to said mold, at least upon one of said cavity and said first port, for demolding the icon from said mold, via said first port.

19. The method according to claim 18 further including the step of:
providing elasticity to said mold, at least around said first port; and
increasing the cross section of said first port by said applying pressure, to enable demolding removal of the icon through said first port, while not exceeding the elastic capability of said mold.

20. The method according to claim 19 in which:
said applying pressure is in the form of applying negative pressure around said mold.

21. The method according to claim 19 in which:
said applying pressure is in the form of applying positive pressure;
said applying is into a second port of said mold and thereby into said cavity and onto the icon at a location remote from said first port.

22. The method according to claim 18 including the step of:
further feeding into the cavity of the mold a second fluid material, which is different from said first fluid material, said step of feeding the first material being less than that for filling the cavity.

23. The method according to claim 18 in which said step of waiting includes:
cooling the first fluid material in the cavity, to reduce the duration of said waiting.

24. A cast icon product made according to the method of claim 18.
